(19) United States
(12) Patent Application Publication
(10) Pub. No.: US 2021/0363965 A1
(43) Pub. Date: Nov. 25, 2021

(54) METHOD FOR OPERATION OF A SYSTEM FOR AIRBORNE WIND ENERGY PRODUCTION AND RESPECTIVE SYSTEM

(71) Applicant: AMPYX Power B.V., Al The Hague (NL)

(72) Inventors: Sebastiaan Petra Jaak ENGELEN, BA Den Haag (AU); Giovanni LICITRA, LR Den Haag (NL); Paul David WILLIAM, Tarneit VIC (AU)

(21) Appl. No.: 17/397,469

(22) Filed: Aug. 9, 2021

Related U.S. Application Data
(63) Continuation of application No. 16/342,549, filed on Apr. 17, 2019, now abandoned.

(30) Foreign Application Priority Data
Oct. 19, 2016 (DE) 10 2016 012 490.3

(51) Int. Cl. F03D 5/00; F03D 7/02

(52) U.S. Cl. CPC F03D 5/00; F03D 7/0288; Y02E 10/72; F05B 2240/921; Y02E 10/70; F03D 7/028

(57) ABSTRACT

A method for operating a system for airborne wind energy production having a ground station, a glider with an airfoil, and a tether for connecting the glider with the ground station, which has an electrical rotary machine connected to a reel for storing excess length of tether. The method includes operating the system in a regular operating mode with repeated operation cycles. Each cycle includes a production phase with increasing free length of the tether and a reel-in phase with decreasing free length of the tether. The method further includes monitoring wind conditions and changing the operation of the system to a low wind operation mode when the monitored wind conditions drop below a predetermined lower wind condition threshold or to a high wind operation mode when the monitored wind conditions raise above a predetermined upper wind condition threshold. And, a system configured to operate in accordance with the method.

### CROSS-REFERENCE TO RELATED APPLICATIONS

The present application is a continuation of U.S. application Ser. No. 16/342,549, filed Apr. 17, 2019, which application is U.S. National Stage of PCT/EP2017/025311, filed Oct. 18, 2017, and claims priority to DE 10 2016 012 490.3, filed Oct. 19, 2016.

### BACKGROUND OF INVENTION

### Field of Invention

The invention relates to a method for operation of a system for airborne wind energy production, said system comprising a ground station, an airborne glider with an airfoil, and a tether connecting said glider with said ground station, said ground station comprising a rotatable reel for storing excess length of said tether and an electrical rotary machine in effective connection to said reel, wherein said system is operated in a regular operation mode with a repeated operation cycle, said operation cycle comprising a production phase with increasing free length of tether including flying said glider away from said ground station and producing energy by driving said electrical rotary machine via the tether using lift generated by said airfoil of said glider exposed to wind, and said operation cycle further comprising a reel-in phase with decreasing free length of tether including flying said glider towards said ground station.

The invention further relates to a respective system for airborne wind energy production.

### Brief Description of Related Art

With such a system, which for instance is known from EP 2 631 468 A1, electric power usually is produced by steering the glider to follow a high-lift flight pattern during the first operating phase, which results in high load on the tether, which can be used to drive an electrical machine at the ground station. During the second operating phase, the glider usually is steered to follow a low-lift flight pattern with the electrical machine at the ground station reeling in excess length of the tether, thereby consuming much less electricity than generated during the first operating phase.

Likewise traditional wind turbines, systems for airborne wind energy production usually are intended for automated operation, requiring a high level of operational safety. These systems also need to be operable in a large range of wind conditions, with optimized efficiency and with few down-time for economic reasons.

### BRIEF SUMMARY OF THE INVENTION

It is an object of the invention to provide for a method for operation of a system for airborne wind energy production ensuring both operational safety and economic viability.

This object is achieved by a method for operation of a system for airborne wind energy production, said system comprising a ground station, an airborne glider with an airfoil, and a tether connecting said glider with said ground station, said ground station comprising a rotatable reel for storing excess length of said tether and an electrical rotary machine in effective connection to said reel, wherein said system is operated in a regular operation mode with a repeated operation cycle, said operation cycle comprising a production phase with increasing free length of tether including flying said glider away from said ground station and producing energy by driving said electrical rotary machine via the tether using lift generated by said airfoil of said glider exposed to wind, and said operation cycle further comprising a reel-in phase with decreasing free length of tether including flying said glider towards said ground station, wherein the method according to the invention is characterized in that wind conditions are monitored and operation of said system is changed to a low wind operation mode when monitored wind conditions drop below a predetermined lower wind condition threshold and/or to a high wind operation mode when monitored wind conditions raise above a predetermined upper wind condition threshold.

Here, the term wind conditions in particular refers to one or more parameters appropriate to characterize a wind condition. These parameters may include but are not limited to wind speed, wind direction, or frequency, duration, and peak wind speeds of gusts.

A glider or sailplane in terms of the invention in particular is a fixed wing, heavier-than-air aircraft, wherein on-board steering means allow for full flight maneuverability of the glider around its longitudinal axis, its lateral axis and its vertical axis. In terms of the invention, these three principle axes form a Cartesian coordinate system, wherein the origin of said coordinate system is defined to be at the center of gravity of the glider.

It is an aspect of the invention to provide distinct operation modes for regular operation, where priorities lie in maximum energy production, and low and/or high wind operations, where priorities lie in risk mitigation to assure safety. Thus, the invention allows for separately optimizing operation during these operation modes, which in particular is beneficial when implementing automated operation routines.

In a preferred embodiment of the invention, said operation cycle of said regular operation mode comprises a first transitional phase between a production phase and the consecutive reel-in phase and/or wherein said operation cycle of said regular operation mode comprises a second transitional phase between a reel-in phase and the consecutive production phase.

Having a first transitional phase enhances operational safety, for instance because termination of the production phase is enabled at any time without being constrained by boundary conditions for starting the reel-in phase. The second transitional phase enables to smoothly transfer flight operation of the glider into optimal conditions for starting the next production phase without being constrained by operation of the reel and/or the electrical rotary machine.

It is further beneficial when operation modes are changed during said first transitional phase and/or said second transitional phase. Most stable system operation is expected when operation modes are changed during said first transitional phase.

Maximum energy yield is expected when during said production phase, flight of said glider is controlled for maximum lift and a tension of said tether is controlled for maximum power output, in particular via torque control by said electrical rotary machine. In particular, the term power output refers to the instantaneous power transferred to electricity or electric energy, respectively, by means of the electrical rotary machine.

In order to avoid system overload or to mitigate other hazards to system structure and/or operation, it is further preferred that power output of said system is reduced by temporarily reducing the efficiency of said system for power production.

Here, efficiency refers to the fraction of energy present in wind, which is actually harvested and converted into electricity by the system.

One way to temporarily reduce system efficiency according to the invention is by retaining tension of said tether above a predetermined tension threshold, wherein said tension threshold in particular is a function of wind conditions and/or of system design parameters and/or of system state parameters. This is for instance possible by adjusting counter-torque of the electrical rotary machine, which in particular is or can be torque-controlled. Increasing tension of the tether at low wind conditions can increases airspeed of the glider at the cost of power output, which in particular is beneficial to ensure above-critical airspeed of the glider.

Another way to temporarily reduce system efficiency according to the invention is by retaining lift of said glider below a predetermined lift threshold, wherein said lift threshold in particular is a function of wind conditions and/or of system design parameters and/or of system state parameters. This is for instance possible by reducing the angle of attack of the glider in flight. If foreseen by glider design, lift can also be reduced by altering the effective aerodynamic profile of the wing, for instance by means of flaps, if available. Retaining lift below threshold enables to avoid critical loads on the glider structure. Also, over-powering the generated is effectively avoidable.

An alternative to decreasing lift is increasing drag of the glider, for instance by means of air brakes, if available.

Yet another way to temporarily reduce system efficiency according to the invention is by increasing an elevation and/or a size of a flight pattern for said glider. This changes the angle of the wind with respect to at least parts of the flight path of the glider, potentially reducing the theoretically maximum amount of energy in the wind accessible for extraction. Often, raising the elevation makes system operation, in particular flight control, more robust against gusts. Another aspect of increased pattern size is reduced turning radii, which makes safe flight operation less demanding.

It is further preferred when said low wind operation mode includes a repeated operation cycle, said operation cycle comprising a first phase with increasing free length of tether including flying said glider away from said ground station, and said operation cycle further comprising a second phase with decreasing free length of tether including flying said glider towards said ground station, wherein said glider is pulled towards said ground station via said tether during at least a part of said second operating phase, thereby increasing velocity of said glider, wherein additional velocity is used to raise altitude of said glider during the following second operating phase.

Thus, the invention enables the glider to stay airborne when wind conditions are insufficient to generate at least the lift necessary to support the glider's own weight. This avoids landing the glider, which is a risky operation requiring complex technical measures and/or manual intervention by a human operator. Another aspect of having the glider airborne is that regular operation can resume as soon as wind conditions are sufficient, avoiding the need to launch the glider beforehand.

Another preferred embodiment of the invention is characterized in that said high wind operation mode includes a repeated operation cycle, said operation cycle comprising a production phase with increasing free length of tether including raising altitude of said glider, thereby producing energy by driving said electrical rotary machine via the tether using lift generated by said airfoil of said glider exposed to wind, and said operation cycle further comprising a reel-in phase with decreasing free length of tether including lowering altitude of said glider, wherein apart from altitude variations said glider remains essentially stationary.

This way, the invention enables energy production even at wind conditions which are prohibitive for the high loads occurring in cross wind flight in the regular operation mode of the system.

For further risk mitigation, said high wind operation mode preferably comprises controlling flight of said glider to hover stationary, in particular at wind conditions above a predetermined critical wind condition threshold, wherein in particular said critical wind condition threshold is higher than said upper wind condition threshold.

Benefits of keeping the glider airborne have been presented already. However, being airborne at highest wind conditions still is potentially hazardous. Thus, wind conditions rare preferably monitored continuously, wherein said glider is landed upon detection or forecast of potentially hazardous conditions.

The object of the invention as discussed in the beginning is also achieved by a system for airborne wind energy production comprising a ground station, an airworthy glider with an airfoil, and a tether for connecting said glider with said ground station, said ground station comprising a rotatable reel for storing excess length of said tether and an electrical rotary machine in effective connection to said reel, said system further comprising a control mechanism for operation of said system, wherein said system is characterized in that said control mechanism is constructed and designed for operation of said system in accordance with one embodiment of the method according to the invention.

### BRIEF DESCRIPTION OF THE DRAWINGS

The invention is described below, without restricting the general intent of the invention, based on exemplary embodiments with reference to the drawings. The drawings show in:

FIG. 1 a schematic view of a system for airborne wind energy production according to the invention;

FIG. 2a, b schematic illustrations of production phase and reel-in phase, respectively, in regular operation of a system according to the invention;

FIG. 3 a schematic illustrations of operation according to the invention during production phase;

FIG. 4 schematically the power output during production phase according to the invention at an exemplary wind condition;

FIG. 5 schematically the average power output as a function of wind conditions for operation of a system according to the invention;

FIG. 6 schematically the power output during production phase according to the invention at another exemplary wind condition;

FIG. 7 schematically the power output during production phase according to the invention at another exemplary wind condition; and

FIG. 8 schematically operation of a system according to the invention in low wind operation mode.

In the drawings, the same or similar types of elements or respectively corresponding parts are provided with the same reference numbers in order to prevent the elements from needing to be reintroduced.

### DETAILED DESCRIPTION OF THE INVENTION

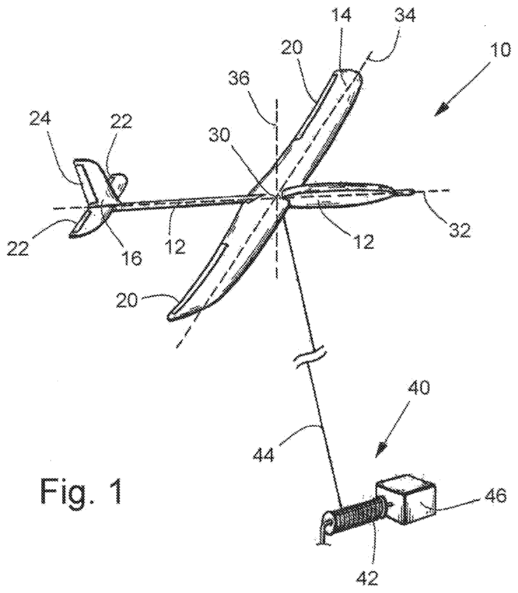

FIG. 1 shows an exemplary embodiment of a system for electric power production from wind according to the invention.

The airworthy or airborne part of the system comprises a glider 10, which in the embodiment depicted in FIG. 1 is designed to be a fixed wing aircraft heavier than air. The glider 10 comprises a fuselage 12, a main wing 14, a tailplane 16 and control surfaces 20, 22, 24. Also shown are the longitudinal axis 32, the lateral axis 34 and the vertical axis 36, which meet at the center of gravity 30 of the glider and which constitute the intrinsic coordinate system of the glider.

The main wing 14 can for instance be constructed from a single wing, as in the embodiment depicted in FIG. 1. However, alternative designs, for instance with a separate main wing 14 on either side of the fuselage 12 are within the scope of the invention.

In flight, the glider 10 is maneuvered by control surfaces, which in the exemplary embodiment comprise ailerons 20 at either side of the main wing 14, as well as elevators 22 and a rudder 24 at the tailplane 16. The control surfaces 20, 22, 24 for instance are hinged surfaces used to induce torque around the principle axes 32, 34, 36 of the glider 10 by aerodynamic means.

Torque around the longitudinal axis 32 is induced by means of the ailerons 20, which can be or are operated simultaneously and in opposite directions. Here, opposite directions means that when the left aileron is moved upwards with respect to the main wing 14, the right aileron is moved downwards. By this, lift is enhanced on the right side of the main wing 14 and reduced on the left side of the main wing 14, causing a torque around the longitudinal axis 32. The resulting movement of the glider 10, a rotation around its longitudinal axis 32, is referred to as rolling.

A rotation of the glider 10 around its lateral axis 34, which is referred to as pitching, is achieved by the elevators 22, which are used to increase or decrease the lift at the tailplane, thereby inducing a torque around the lateral axis 34.

Rotation of the glider 10 around its vertical axis 36, which is referred to as yawing, is induced by the rudder 24.

The glider 10 is connected to the ground station 40 via a tether 44, which is attached to or connected with the glider 10 at a connection means which is preferably arranged close to the center of gravity 30 of the glider 10. This way, varying loads on the tether 44 do not significantly impair the balance of the glider 10 in flight.

At the ground station 40, excess length of the tether 44 is stored on a reel 42, which is connected to an electrical rotary machine 46. The electrical rotary machine 46 is for instance connected to an electricity storage and/or distribution system (not shown) such as a power grid, a transformer station or a large scale energy reservoir. Those skilled in the art will appreciate that the power storage and/or distribution system can be any device or system capable of receiving electricity from and delivering electricity to the rotating electrical machine 46.

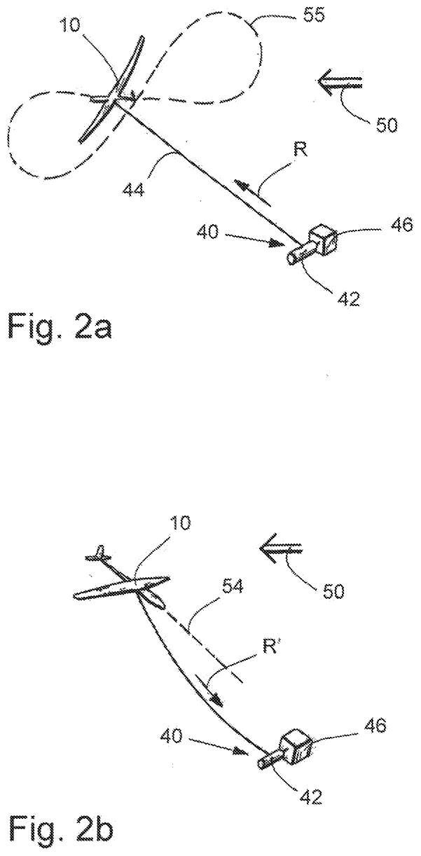

Regular operation of the system shown in FIG. 1 comprises an operation cycle with two main phases, a production phase illustrated in FIG. 2a and a reel-in phase illustrated in FIG. 2b. The direction of tether reeling is indicated in FIGS. 2a and 2b by arrows R and R′, respectively.

In the production phase, the glider 10 is steered to follow a high lift flight pattern indicated by line 55 downwind of the ground station 40. The direction of the wind is indicated by arrow 50. During cross-wind flight, in particular fast cross-wind flight, the airfoil or the main wing 14, respectively, of the glider 10 generates a lift force much larger than required to keep the glider 10 at a given altitude. As a consequence, the glider exerts a pull on the tether 44, which is used to drive the electrical rotary machine 46 as a generator in order to produce electricity.

As long as the tether 44 is reeled out, the glider 10 flies away from the ground station 40. The production phase thus is limited by the overall length of the tether 44.

During the reel-in phase, i.e. for reeling in the tether 44 onto the reel 42, the electrical rotary machine 46 is operated as a motor, while at the same time the glider 10 is steered along a low lift flight pattern 54 in order to minimize pull on the tether 44.

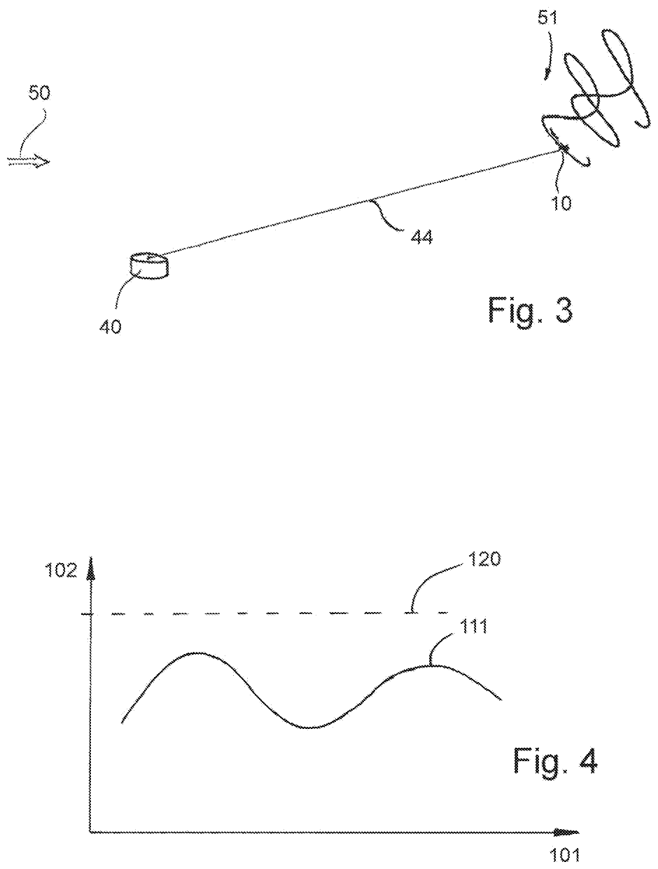

An alternative illustration of exemplary system operation during the production phase is shown in FIG. 3. Again, wind is indicated by arrow 50.

Here, the glider 10 flies along a production flight path 51 downwind of the ground station 40. The production flight path 51 resembles an repeated, essentially figure-eight shaped loop. Elevation, which can be expressed as ratio of altitude of the flight path 51 over distance to the ground station 40, is relatively low, allowing for a small angle between the average tether direction and the wind 50.

FIG. 4 shows the resulting power output 111 for exemplary conditions, wherein horizontal axis 101 shows time in arbitrary units and vertical axis 102 shows power in arbitrary units. As can be seen, power output 111 has a fluctuating component, which mainly results from conversion of kinetic energy into potential energy upon gain in altitude along the flight path 51 and vice versa.

Dashed line 120 indicates the rated power of the generator at the ground station 40.

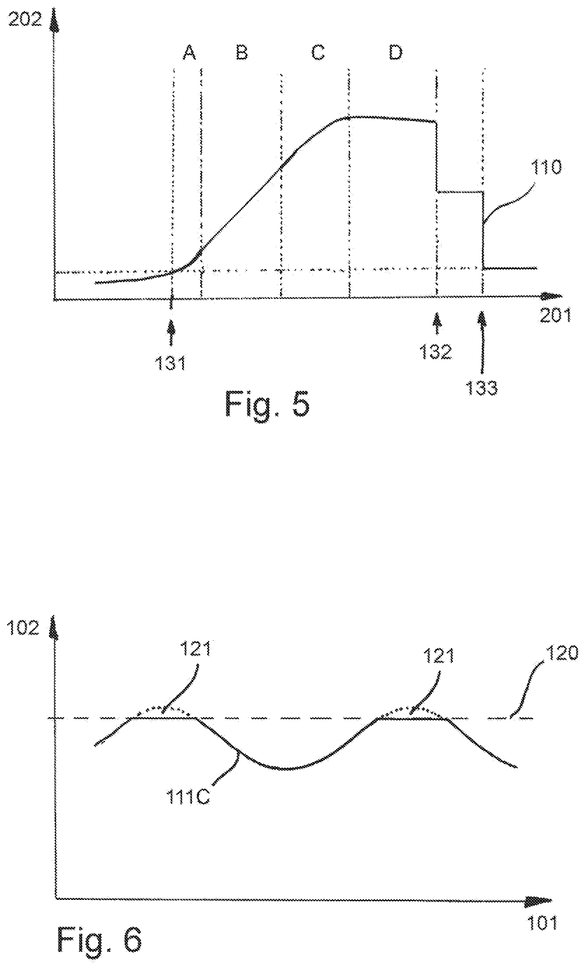

The achievable level of power output 111 depends on wind conditions, in particular on wind speed. FIG. 5 illustrates the average power output 110, wherein horizontal axis 201 shows wind speed in arbitrary units and vertical axis 202 shows average power in arbitrary units.

Indicated with arrows are characteristic thresholds for wind speeds.

Below lower threshold 131, wind conditions are insufficient for regular flight of the glider 10, even without any power production. In other words, energy available for extraction from wind 50 is not even enough to keep the glider 10 airborne.

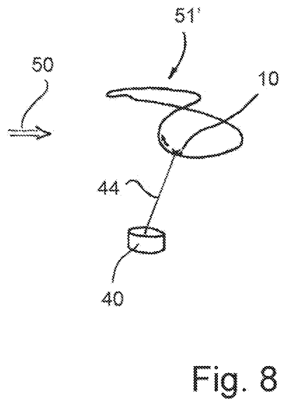

For such low wind conditions, the invention provides for a low wind operation mode, which is illustrated in FIG. 8. In this low wind operating mode, the glider 10 is flown along a holding flight path 51′. When the holding flight path 51′ is close to the ground station, i.e. at a high elevation, as exemplarily shown in FIG. 8, free length of tether 44 is short. This minimizes the extra weight which has to be carried by the glider 10 in addition to its own weight. However, the method according the invention is also applicable for holding flight paths with lower elevation.

The holding flight pattern 51′ resembles a figure-eight shaped closed loop. Distributed along the flight path are reel-out phases, where excess length of tether 44 is increased and reel-in phases, where excess lengths of tether 44 is decreased.

According to the invention, a pulling force is exerted on the tether 44 during at least a part of at least one of the reel-in phases, thereby pulling the glider 10 towards the ground station 40. This increases velocity of the glider 10, which can in turn be used for gain in altitude during the next reel-out phase. In other words, the tether 44 is used to increase kinetic energy of the glider 10, which then is transformed to potential energy and helps keeping the glider 10 aloft.

The invention even allows to fly the glider 10 in the absence of wind 50.

Alternatively, the glider 10 can be landed when wind conditions drop below lower threshold 131. The eventual choice should estimate the expected duration of a low wind period and be based on both economic considerations and risk assessment. In general, there will be a trade-off between power consumption and maintenance costs of keeping the glider 10 aloft versus higher risk of landing.

Further shown in FIG. 5 is upper threshold 132, above which wind conditions are too harsh to ensure safe cross-wind flight of the glider 10. Consequently, regular operation for energy production as described above is limited to wind conditions between lower threshold 131 and upper threshold 132.

Regular operation slightly differs for different ranges of wind conditions, wherein these ranges are indicated by A, B, C, and D, respectively, in FIG. 5.

At wind conditions within range A, the glider 10 is generally controlled to fly for maximum lift, while torque of the generator at the ground station 40 is optimized for maximum energy yield. Within wind condition range A, both tension of the tether 44 and reel-out speed increase with increasing wind speed, resulting in a cubic increase of average power output 110 with increasing wind speed.

At the transition between range A and range B, tension of the tether 44 reaches its design maximum, so that generator torque cannot be increased any further without compromising operational safety of the system.

Therefore, for wind conditions within range B, the generator torque is controlled to maximum tether tension, while flight of the glider 10 is still controlled for maximum lift. Within range B, the reel-out speed increases linearly with increasing wind speed resulting in a linear increase in power output.

The power output 111 shown in FIG. 4 is an example for wind conditions within range A or range B, where for any given time the power output 111 is below the rated generator power 120.

The power output 111C for exemplary wind conditions within range C is shown in FIG. 6. As becomes apparent, there are over-power regions 121, where maximum power output would be above the rated generator power 120, as indicated by dotted line segments. In order to avoid generator overload, the power output 111C has to be capped by decreasing the efficiency of the system for airborne wind energy production. For instance, this can be achieved by temporarily decreasing lift or increasing drag of the glider 10, respectively.

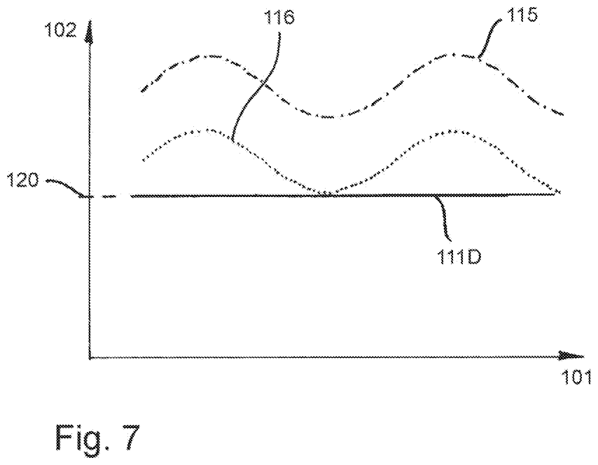

The situation for exemplary wind conditions in range D is depicted in FIG. 7. Here, maximum power output 115, indicated by dash-dotted line, is above the rated generator power 120 for any time during the production phase. As described before, system efficiency needs to be decreased in order to limit the actual power output 111D to the rated generator power 120 at any time.

One approach is to decrease lift and/or increase drag of the glider 10 as described before. However, this will in general result in unnecessarily high loads on the structure of the glider 10, in particular wing and steering surfaces together with the respective hinges and actuators.

In a preferred embodiment of the invention, the elevation of the flight path 51 is increased, which lowers the maximum power output 115 towards optimized power output 116, shown as dotted line. Starting from there, system efficiency is further reduced by decreasing lift or increasing drag of the glider 10, as described before. As a result, the actual power output 111D is constant with time at level of the rated generator power 120.

At particularly gusty wind conditions, it is an option to reduce the targeted power output 111D below the rated generator power 120 in order to increase the safety margin of the system for appropriately reacting to unforeseeable wind gusts without compromising operational or structural safety.

With reference to FIG. 5, it has already been discussed that power production via cross-wind flight of the glider 10 is not an option anymore at wind conditions above upper threshold 132. However, according to the invention it is still possible to generate electricity by flying the glider 10 vertically above the ground station 40 in a pumping mode. Here, lift is periodically increased and decreased, for instance by appropriately controlling the angle of attack. As a result, the glider 10 gains altitude, thereby pulling the tether 44, and consecutively loses altitude allowing the tether 44 to be reeled in.

At even higher wind speeds above critical threshold 133, power generation is terminated completely and the system is controlled solely with the target to minimize risks. Safest option always is to land the glider 10 and to secure it at the ground. When proper risk assessment permits, it is also possible within the scope of the invention to control the glider 10 to hover stationary with flight being controlled to minimum structural load on the glider 10, the tether 44 and the ground station equipment.

Those skilled in the art will appreciate that the production flight path 51 and the holding flight path 51′ are both exemplary embodiments. Other principle shapes such as circular or oval shapes are also meant to be covered by the invention.

What is claimed is:

1. A method for operation of a system for airborne wind energy production that includes a ground station, an airborne glider with an airfoil, and a tether connecting said glider with said ground station, wherein said ground station includes a rotatable reel for storing excess length of said tether and an electrical rotary machine in effective connection to said reel, the method comprising:
operating said system in a regular operation mode with repeated operation cycles, wherein each of said repeated operation cycles includes:
(a) a production phase with increasing free length of the tether including flying said glider away from said ground station and producing energy by driving said electrical rotary machine via the tether using lift generated by said airfoil of said glider exposed to wind, and
(b) a reel-in phase with decreasing free length of the tether including flying said glider towards said ground station,
monitoring wind conditions; and
changing operation of said system to a low wind operation mode when the monitored wind conditions drop below a predetermined lower wind condition threshold or changing operation of said system to a high wind operation mode when the monitored wind conditions raise above a predetermined upper wind condition threshold in order to prioritize risk mitigation over energy production and thereby assure system safety;
wherein said low wind operation mode includes a repeated low wind operation cycle, said low wind operation cycle comprising a first phase with increasing free length of said tether including flying said glider away from said ground station, and said low wind operation cycle further comprising a second phase with decreasing free length of said tether including flying said glider towards said ground station, wherein said glider is pulled towards said ground station via said tether during at least a part of said second phase, thereby increasing a velocity of said glider, and wherein the increased velocity is used to raise an altitude of said glider during a following second phase.

2. The method according to claim 1, wherein each of said operation cycles of said regular operation mode comprises a first transitional phase between the production phase and the reel-in phase, or wherein each of said operation cycles of said regular operation mode comprises a second transitional phase between the reel-in phase and the production phase of a next operation cycle of said regular operation mode.

3. The method according to claim 2, wherein operation of the system is changed to the low or the high operation modes during said first transitional phase or said second transitional phase.

4. The method according to claim 1, wherein during said production phase, flight of said glider is controlled for maximum lift and a tension of said tether is controlled for maximum power output via a torque control by said electrical rotary machine.

5. The method according to claim 1, wherein power output of said system is reduced by temporarily reducing efficiency of said system for power production.

6. The method according to claim 5, wherein system efficiency is temporarily reduced by retaining tension of said tether above a predetermined tension threshold, and wherein said tension threshold is a function of wind conditions or of system design parameters or of system state parameters.

7. The method according to claim 5, wherein system efficiency is temporarily reduced by retaining lift of said glider below a predetermined lift threshold, wherein said lift threshold is a function of wind conditions or of system design parameters or of system state parameters.

8. The method according to claim 5, wherein system efficiency is temporarily reduced by increasing an elevation or a size of a flight pattern for said glider.

9. The method according to claim 1, wherein said high wind operation mode includes a repeated high wind operation cycle, said high wind operation cycle comprising the production phase with increasing free length of tether including raising an altitude of said glider, thereby producing energy by driving said electrical rotary machine via the tether using lift generated by said airfoil of said glider exposed to wind, and said high wind operation cycle further comprising the reel-in phase with decreasing free length of tether including lowering the altitude of said glider, wherein apart from altitude variations said glider remains substantially stationary.

10. The method according to claim 1, wherein said high wind operation mode comprises controlling flight of said glider to hover stationary at wind conditions above a predetermined critical wind conditions threshold, and wherein said critical wind conditions threshold is higher than said predetermined upper wind condition threshold.

11. A system for airborne wind energy production comprising:
a ground station;
a glider with an airfoil; and
a tether for connecting said glider with said ground station;
wherein said ground station comprises a rotatable reel for storing excess length of said tether and an electrical rotary machine in effective connection to said reel, and
wherein said system is configured to operate in accordance with the method of claim 1.
